(19) United States
(12) Patent Application Publication
(10) Pub. No.: US 2018/0127645 A1
(43) Pub. Date: May 10, 2018

(54) SELF-SUPPORTING PROPPANT WITH IMPROVED PROPPANT PACK CONDUCTIVITY

(71) Applicant: Halliburton Energy Services, Inc., Houston, TX (US)

(72) Inventors: Prashant D. CHOPADE, Kingwood, TX (US); Philip D. NGUYEN, Houston, TX (US)

(21) Appl. No.: 15/569,004

(22) PCT Filed: Aug. 31, 2015
(86) PCT No.: PCT/US2015/047686

§ 371 Date: Oct. 24, 2017

(51) Int. Cl. C09K 8/80; E21B 43/267

(52) U.S. Cl. CPC C09K 8/805; C09K 2208/26; E21B 43/267

(57) ABSTRACT

A proppant that is self-supporting includes a proppant particulate, a breaker coating adhered to a surface of the proppant particulate, and a hydrogel coating adhered to the breaker coating. A method of using a proppant particulate in a subterranean formation includes coating the proppant particulate with a breaker coating and a hydrogel. The method also includes introducing a fracturing fluid and the proppant particulate into a subterranean formation through a well bore, placing the proppant particulate in a fracture of the subterranean formation, and retrieving the fracturing fluid from the subterranean formation.

### BACKGROUND

### 1. Field

The present disclosure relates to oil and gas exploration and production and more particularly to a treated self-supporting proppant with a plurality of coatings used in fracturing formations.

### 2. Description of Related Art

When producing oil or gas from a well, it is often desired to stimulate the flow of hydrocarbons using hydraulic fracturing. In select formations, both new wells and existing wells can be fractured to attempt to achieve higher production rates from those formations. Fracturing is accomplished by injecting fracturing fluid into the well under a pressure high enough to cause the subterranean geological formations containing the hydrocarbons to fracture. When successful, this process allows the hydrocarbons to flow into the well bore at an increased rate, but without further interventions the newly formed openings often close. In order to open a fracture and maintain the fracture in an open position, a propping agent or “proppant” is injected along with the fracturing fluid to preserve the opening. Specifically, by mixing proppant and fracturing fluid and then pumping the mix into a well that penetrates the formation the proppant carried by the fracturing fluid flows into the fractures and maintains the fractures in an open position. The proppant in the fractures holds the fractures open after pressure is lowered and production is resumed. Various fluids have been disclosed for use as the fracturing fluid, including mixtures of water, hydrocarbons, nitrogen, carbon dioxide, polymers, surfactants, and other additives.

### BRIEF DESCRIPTION OF DRAWINGS

The following figures are included to illustrate certain aspects of the present disclosure and should not be viewed as exclusive embodiments. The subject matter disclosed is capable of considerable modifications, alterations, combinations or derivatives, and equivalents in form and function, without departing from the scope of this disclosure.

FIG. 1 illustrates a block diagram of a fracturing system that may be used in accordance with certain illustrative embodiments.

FIG. 2 illustrates an example of a subterranean formation in which a fracturing operation may be performed in accordance with certain illustrative embodiments.

FIG. 3 illustrates a schematic view of a proppant particulate that is coated to create a self-supporting proppant particulate by placing a breaker coating directly on the outer surface of the proppant particulate and then placing a hydrogel coating on the breaker coating according to an illustrative embodiment.

FIG. 4 illustrates a schematic view of a self-supporting proppant particulate in a dry state and a self-supporting proppant particulate in a wet state used during injection and placement according to an illustrative embodiment.

FIG. 5 illustrates a schematic view of an exemplary arrangement of a plurality of self-supporting proppant particulates in a dry state and a plurality of self-supporting proppant particulates in a wet state according to an illustrative embodiment.

FIGS. 6A and 6B illustrate schematic views of a plurality of self-supporting proppant particulates in a wet state being initially placed in a created fracture while still maintaining all outer coatings on the proppant particulate according to an illustrative embodiment.

FIG. 7 illustrates a schematic view of a breaker coating on a proppant particulate breaking and separating off the hydrogel coating from the proppant particulate according to an illustrative embodiment.

FIG. 8 illustrates a schematic view of a plurality of proppant particulates in a fracture according to an illustrative embodiment.

FIG. 9 illustrates a flowchart of a method for treating a proppant particulate with a breaker coating and a hydrogel coating.

### DETAILED DESCRIPTION OF ILLUSTRATIVE EMBODIMENTS

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

The term “coating,” and grammatical variants thereof (e.g., “coated,” “coat,” and the like) with reference to coating a surface (e.g., a face of a formation or an outer surface of proppant particulates) described herein is not meant to limit the interaction by implying a complete coverage of a surface. Rather coating can be understood to mean that at least about 50% (or at least about 60%, 70%, 80%, 90%, or 100%) of the surface is covered. As used herein, “derivative” refers to any compound that is made from one of the listed compounds, for example, by replacing one atom in the compound with another atom or group of atoms, ionizing the compound, or creating a salt of the compound. “Derivative” also refers to any unneutralized species of any of the listed compounds.

As used herein, the phrases “hydraulically coupled,” “hydraulically connected,” “in hydraulic communication,” “fluidly coupled,” “fluidly connected,” and “in fluid communication” refer to a form of coupling, connection, or communication related to fluids, and the corresponding flows or pressures associated with these fluids. In some embodiments, a hydraulic coupling, connection, or communication between two components describes components that are associated in such a way that fluid pressure may be transmitted between or among the components. Reference to a fluid coupling, connection, or communication between two components describes components that are associated in such a way that a fluid can flow between or among the components. Hydraulically coupled, connected, or communicating components may include certain arrangements where fluid does not flow between the components, but fluid pressure may nonetheless be transmitted such as via a diaphragm or piston or other means of converting applied flow or pressure to mechanical or fluid force.

While a portion of a well bore may in some instances be formed in a substantially vertical orientation, or relatively perpendicular to a surface of the well, the well bore may in some instances be formed in a substantially horizontal orientation, or relatively parallel to the surface of the well. The well bore may include portions that are partially vertical (or angled relative to substantially vertical) or partially horizontal (or angled relative to substantially horizontal). In some well bores, a portion of the well bore may extend in a downward direction away from the surface and then back up toward the surface in an “uphill,” such as in a fish hook well. The orientation of the well bore may be at any angle leading to and through the reservoir.

The present disclosure relates generally to a self-supporting proppant particulate and a method of treating a proppant particulate with one or more coatings to create a self-supporting proppant particulate that can be used in a fracturing fluid, which may also be called a hydraulic fracturing fluid.

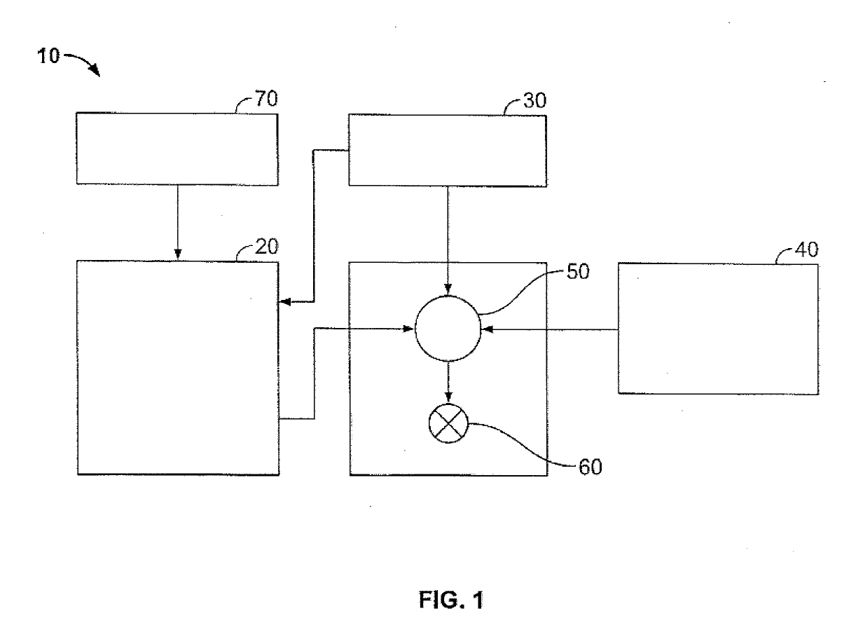

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. The system may also include additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 to source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants at other times, and combinations of those components at yet other times.

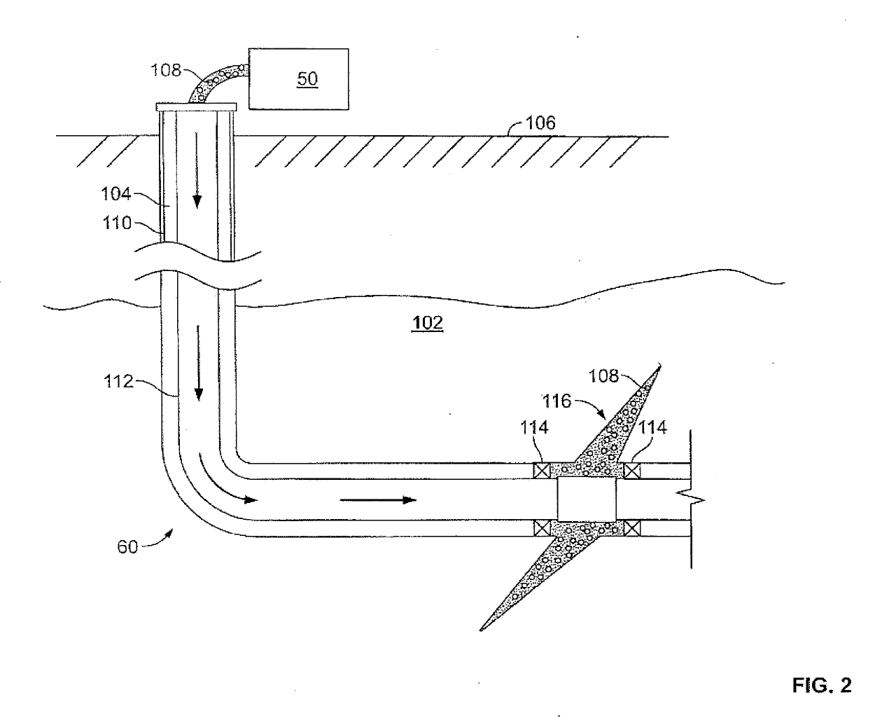

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro-jetting and/or other tools.

The well is shown with a work string 112 depending from the surface 106 into the well bore 104. The pump and blender system 50 is coupled to a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

In accordance with one or more embodiments of the disclosure, to accomplish the placement of proppant particulates inside a fracture, the proppant particulates are each individually coated in a breaker coating and a hydrogel coating creating self-supporting proppant particulates. The self-supporting proppant particulates are suspended in the fracturing fluid that is pumped to its subterranean destination. This occurs when the hydrogel coating expands and gels effectively increasing the viscosity of the fracturing fluid and suspending the proppant particulates to prevent the proppant particles from settling. The viscosity of the fracturing fluid may be specifically adjusted by the addition of synthetic or naturally-based polymers. For example, additional gelling agents can be used in fracturing fluids in order to adjust the viscosity and allow the fracturing fluid to carry sufficient amounts of proppant particulates downhole.

Upon completion of the high pressure fracturing and placement of the self-supporting proppant particulates, the fracturing fluid is desirably removed from the formation. In order to effectively remove the fracturing fluid, the viscosity of the fluid should be reduced which is referred to as “breaking” the gel. Various chemicals may be added to these fracturing fluids in order to reduce the viscosity of the gel and return the fluid to a pre-gel consistency. The chemical substance responsible for breaking the gel is referred to as a “breaker” which may include enzymes and oxidizing breakers. Examples of oxidizing breakers include ammonium persulfate, sodium persulfate, potassium persulfate, sodium peroxide, sodium chlorite, sodium, lithium or calcium hypochlorite, potassium perphosphate, and sodium perborate. Further, a proppant particulate may be coated to create a self-supporting proppant particulate that can be suspended in a fluid by coating the proppant particulate directly with a hydrogel. However, the hydrogel is directly connected to the proppant particulate while the breaker is included in the fracturing fluid which must then gain access to the surface of the hydrogel on the proppant and then react and break the hydrogel from the outside working toward the proppant particulate at the center. Thus, after the fracturing application is complete hydrogel polymer residue remains on the surface of the proppant grains. This residue reduces the proppant conductivity, thereby impacting the hydrocarbon production.

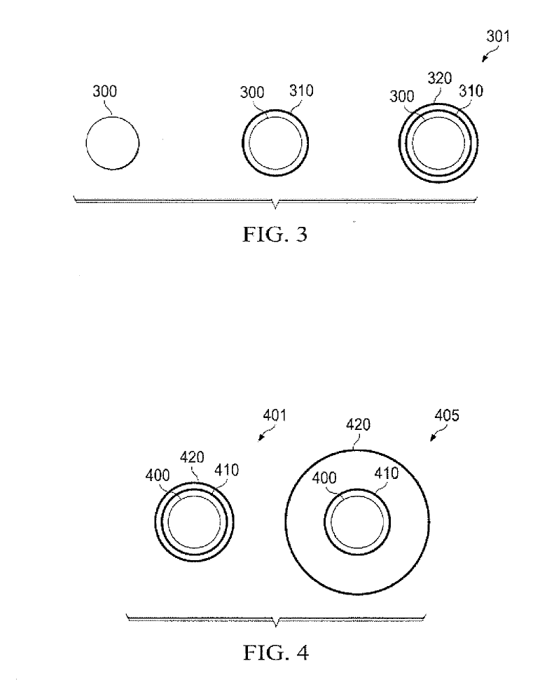

FIG. 3 shows a proppant particulate 300 that is coated to create a self-supporting proppant particulate 301 by placing a breaker coating 310 directly on the outer surface of the proppant particulate 300 and then placing a hydrogel coating 320 on the breaker coating 310 according to an illustrative embodiment. This process of coating particulate is extended to a plurality of proppant particulates and is done so in a dry state where the fracturing fluid is not yet included. The proppant particulate may be any from a group consisting of sand, treated sand, crushed nut hulls, glass beads, polymer beads, man-made ceramic materials, aluminum oxide, and combinations or derivative thereof.

The breaker coating 310 may not react with the hydrogel coating 320 in a dry state, but when mixed with the fracturing fluid the breaker coating 310 begins to break up the crosslinking and/or molecular structure of the hydrogel coating 320. Particularly, the breaker coating 310 breaks up the crosslinking and/or the molecular structure of polymer chains in the hydrogel coating 320 in a wet state at a rate based on at least one of particle saturation time, temperature, pressure, concentration, time elapsed, or any combination thereof. For example, the breaker coating 310 may be timed to delay the breaking of a hydrogel coating 320 until a desired amount of time has elapsed, usually long enough to allow a fracturing fluid to deliver sufficient self-supporting proppant into the created fractures. By breaking the hydrogel coating 320 after successful delivery of the self-supporting proppant particulate 301, the reduced viscosity fracturing fluid may then be recovered along with the broken gel monomers leaving the delivered proppant particulate 300 behind in the formation to prop open the created fractures. In one or more embodiments, a combination of two or more breaker agents may be coated onto the proppant particulate 300. In some embodiments, a much smaller amount of the same or different breaker agents may be added to the fracturing fluid itself.

In some embodiments, the breaker coating includes a degradable material. For example, the breaker coating may include a poly(lactic) acid and/or a poly(glycolic) acid. Specifically, the breaker coating for use in the fracturing fluid may include, but is not limited to, one or more from a group consisting of an oxidative breaker, an acid breaker (e.g., a chelating agent breaker), a delayed release acid breaker, a delayed release enzyme breaker, a temperature activated breaker, a hydrolysable ester breaker, and combinations or derivative thereof. For example, some breaker coating products than may be used include ViCon FB, ViCon SP, ViCon AP, GBW-10, and GBW-30, all commercially-available products from Halliburton. The oxidative breaker may be one or more from a group consisting of, but not limited to, organic peroxides, alkali metal persulfates, alkali metal chlorites, bromates, chlorates, hypochlorites, permanganates, and combinations or derivative thereof.

The acid breaker may be, for example, one or more from a group consisting of, but not limited to, hydrochloric acid, hydrofluoric acid, hydrobromic acid, hydroiodic acid, sulfuric acid, nitric acid, boric acid, chromic acid, ethylenediaminetetraacetic acid, nitrilotriacetic acid, hydroxyethylethylenediaminetriacetic acid, dicarboxymethyl glutamic acid tetrasodium salt, diethylenetriaminepentaacetic acid, propylenediaminetetraacetic acid, ethylenediaminedi(o-hydroxyphenylacetic) acid, glucoheptonic acid, gluconic acid, and combinations or derivative thereof. The delayed release acid breakers may be, for example, one or more from a group consisting of, but are not limited to, acetic anhydride and organic and inorganic acids such as fumaric acid, benzoic acid, sulfonic acid, phosphoric acids, aliphatic polyesters, poly(lactides), poly(anhydrides), poly(amino acids), any derivatives thereof, and combinations or derivative thereof. Acid breakers may be particularly useful for breaking fracturing fluids comprising borate or metal crosslinking agents. Further, the breaker coating may release an acid and/or alcohol in the presence of a base liquid, such as an aqueous base fluid, particularly the fracturing fluid.

Examples of delayed release enzyme breakers include, but are not limited to, one or more from a group consisting of alpha and beta amylases, exo- and endo-glucosidases, amyloglucosidase, oligoglucosidase, invertase, maltase, cellulase, hemicellulase, endo-glucosidase, endo-xylanase, exo-xylanase, and combinations or derivative thereof. In some embodiments, the enzyme breakers are enzymes or combinations of enzymes that attack glucosidic linkages of a cellulose gelling agent backbone and degrade the gelling agent into mostly monosaccharide and disaccharide units.

Examples of suitable temperature activated breakers include, but are not limited to, one or more from a group consisting of alkaline earth metal peroxides, such as calcium peroxide and magnesium peroxide, zinc peroxide, and combinations or derivative thereof. Temperature activated breakers may activate by being heated by a subterranean formation in which they are placed, or by another external heat source. Examples of suitable hydrolysable esters include, but are not limited to, one or more from a group consisting of sorbitol, catechol, dimethyl glutarate and mixtures of dimethyl glutarate, dimethyl succinate, dimethyl adipate, and combinations or derivative thereof.

In certain embodiments, the breaker may be present in the fracturing fluid in an amount in the range of from about 0.001% to about 5% by weight of the gelling agent included in the treatment fluid, encompassing any value and subset therebetween. Each of these values may depend on a number of factors including, but not limited to, the amount and type of gelling agent included in a treatment fluid, the amount and type of crosslinking agent, if any, included in a treatment fluid, the desired time for breaking the treatment fluid, and the like, and combinations or derivative thereof.

In some embodiments, the breaker coating 310 may include a tackifying agent to adhere the breaker coating 310 to the proppant particulate 300. The tackifying agent in the breaker coating 310 may also help adhere the hydrogel coating 320 to the breaker coating 310. Additionally, the tackifying agent can adhere the breaker coating 310 to the proppant particulate 300 and the hydrogel coating 320 to the breaker coating 310 in a dry state. This is useful when creating and transporting the self-supporting proppant particulate 301. Then, when mixed with the fracturing fluid placing the self-supporting proppant particulate 301 into a wet state, the tackifying agent displays hydrophobic properties. The hydrophobic nature of the tackifying agent in a wet state then repels the hydrophilic hydrogel coating 320 thereby helping the breaker coating 310 achieve the desire separation of the hydrogel coating 320 from the proppant particulate 300. Any number or combination of tackifying agents may be used, for example, the tackifying agent used may be any one or more from a group consisting rosins, terpenes, aliphatic resins, cycloaliphatic resins, aromatic resins, hydrogenated hydrocarbon resins, terpene-phenol resins, or combinations or derivative thereof.

In some embodiments, the tackifying agent may include polyamides that are liquid or form into a solution at temperature in the subterranean formation such that they are, non-hardening when introduced into the subterranean formation. According to an embodiment, a particular tackifying agent that can be used is a condensation reaction product that includes a polyacid and a polyamine. A tackifying agent that is non-aqueous may include amounts of dibasic acids containing some trimer and higher oligomers and also small amounts of monomer acids that are reacted with polyamines. Other polyacids for use as a non-aqueous tackifying agent may include, but are not limited to, trimer acids, synthetic acids produced from fatty acids, maleic anhydride, acrylic acid, and the like, and combinations or derivative thereof. Additional compounds which may be used as non-aqueous tackifying agents include liquids and solutions of, for example, polyesters, polycarbonates, silyl-modified polyamide compounds, polycarbamates, urethanes, natural resins such as shellac, and the like. Combinations or a derivative of these may be suitable as well.

In some embodiments, the release of the breaker coating may be delayed by an encapsulating agent. For example the encapsulating agent may be coated onto proppant particulate 300 that is coated with a breaker coating 310 providing additional time before the breaker coating 310 comes into contact with, and starts to break, a hydrogel coating 320 that is found on the outer surface of the encapsulating agent. Specifically, the proppant particulate 300 that has been coated with the breaker coating 310, but has not yet been coated with the hydrogel coating 320, may be coated with the encapsulating agent followed by the hydrogel coating 320. The encapsulating agent may be any material capable of delaying the activity of the breaker including, but not limited to, those discussed herein with reference to crosslinking agents. Further, the encapsulating agent may be a degradable coating that degrades downhole. Alternatively, the encapsulating agent may be a porous coating through which the breaker may diffuse slowly. Thus, the treated proppant particulate 300 is coated with one or more layers of an encapsulating agent such that the breaker coating 310 is released after the proppant particulate 300 has been placed in fractures. The encapsulating agent may be one or more from a group consisting of Polyvinylidene Chloride (PVDC), Polyvinylidene Acetate (PVDA), polylactic acid, polyvinyl alcohol, and combinations or derivative thereof.

In some embodiments, proppant particulate may include a consolidating agent that may also be included directly in the fracturing fluid. The consolidating agent is provided by coating a surface of the proppant particulate with the consolidating agent. The consolidating agent coated proppant particulate may have enhanced grain to grain contact between individual proppant particulates. Specifically, the consolidating agent coated proppant particulate may have enhanced contact with other proppant particulates that are also coated with a consolidating agent as well as those that may not have a consolidating agent coating. The consolidating agent coated proppant particulate may also have enhanced contact with an interior surface of the fracture.

According to one or more embodiments, a consolidating agent may include, but is not limited to, a non-aqueous tackifying agent, an aqueous tackifying agent, a silyl-modified polyamide compound, a curable resin, a crosslinkable aqueous polymer composition, a polymerizable organic monomer composition, a zeta potential-modifying aggregating composition, a silicon-based resin, a binder, a consolidation agent emulsion, and combinations or derivative thereof. Such combinations may include, for example, use of a non-curable consolidating agent (e.g., one that does not cure into a solid, hardened mass) and/or a curable consolidation agent.

The consolidation agents may be coated onto a surface of the particulates before inclusion into a fracturing fluid to be pumped into the formation (i.e., pre-coated). Particularly, the consolidating agent may be coated onto a surface of the proppant particulate sometime during coating of the breaker coating and the hydrogel coating. Alternatively, the consolidating agent may be coated on-the-fly by including the consolidating agent in the fracturing fluid along with the self-supporting proppant particulates directly prior to pumping the fluid into the formation. As used herein, the term “on-the-fly” refers to performing an operation during a subterranean treatment that does not require stopping normal operations. Accordingly, the consolidating agent may enhance a structure of proppant particulates by providing additional structural support to withstand closure stress. The consolidating agent may help aggregate the proppant particulates to form a fluidic seal. Moreover, the consolidating agent may stabilize soft portions of a fracture, and prevent particulate embedment therein.

FIG. 4 illustrates a schematic view of a self-supporting proppant particulate in a dry state 401 and a self-supporting proppant particulate in a wet state 405 used during, transport, injection, and placement into a well bore according to an illustrative embodiment. The self-supporting proppant particulate in a dry state 401 consists of a proppant particulate 400 that has a first coating comprising of a breaker coating 410. Adhered to the breaker coating 410 is a hydrogel coating 420 in a dry unexpanded state. The self-supporting proppant particulate in a wet state 405 consists of the proppant particulate 400 with the breaker coating 410. Adhered to the breaker coating 410 is the hydrogel coating 420 in a wet, expanded state due to the fluid absorbed by the hydrogel.

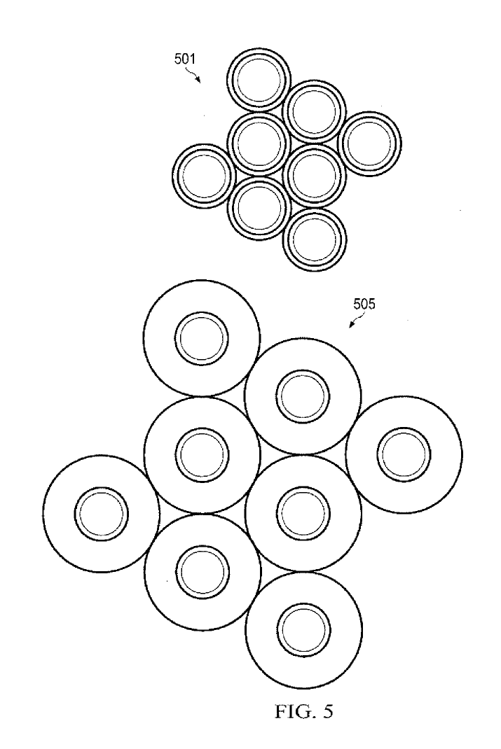

FIG. 5 illustrates a schematic view of an exemplary arrangement of a plurality of self-supporting proppant particulates in a dry state 501 and a plurality of self-supporting proppant particulates in a wet state 505 according to an illustrative embodiment. It can be appreciated that as the hydrogel expands, by saturating itself with the fracturing fluid, the proppant particulates spread outward as compared to the other proppant particulates, thus causing the proppant particulates to become self-supporting in the remaining fracturing fluid.

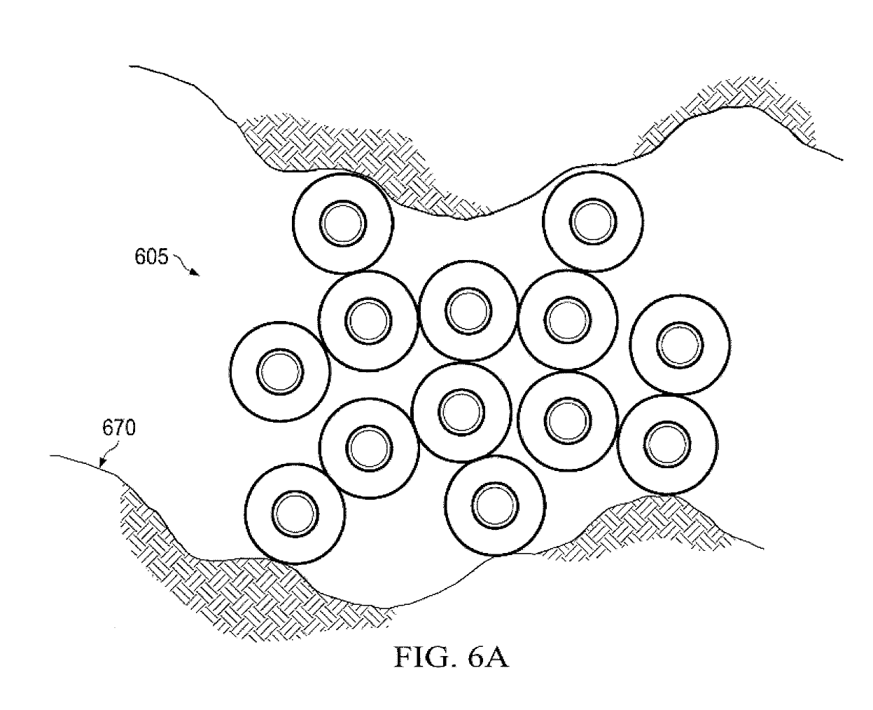

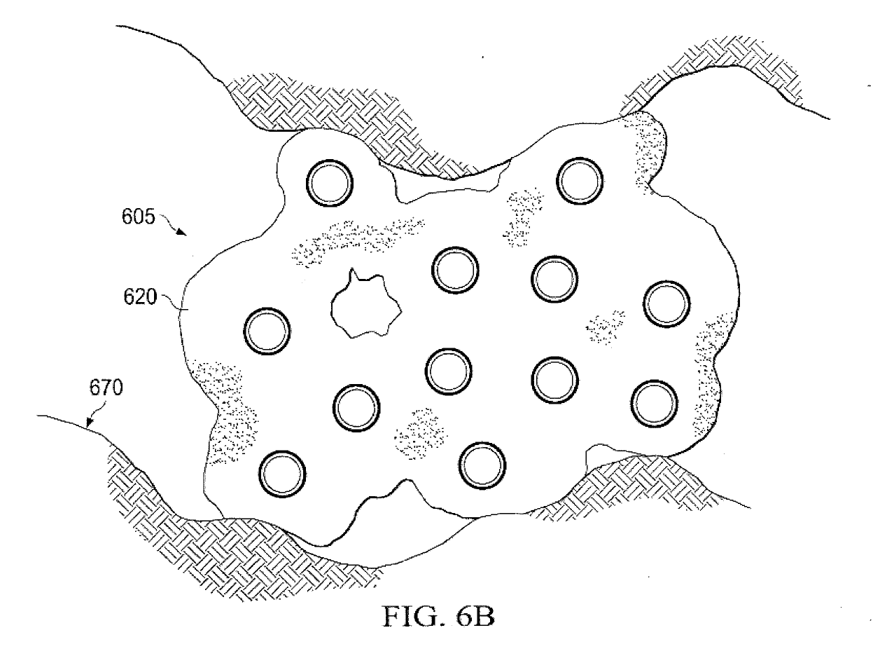

FIG. 6A illustrates a schematic view of a plurality of self-supporting proppant particulates 605 in a wet state being initially placed in a fracture 670 while still maintaining all outer coatings on the proppant particulate according to an illustrative embodiment. As time passes the hydrogel 620 may take on more of a gel-like consistency as the proppant, hydrogel, and fluid mix moves through the fracture 670 as shown in FIG. 6B.

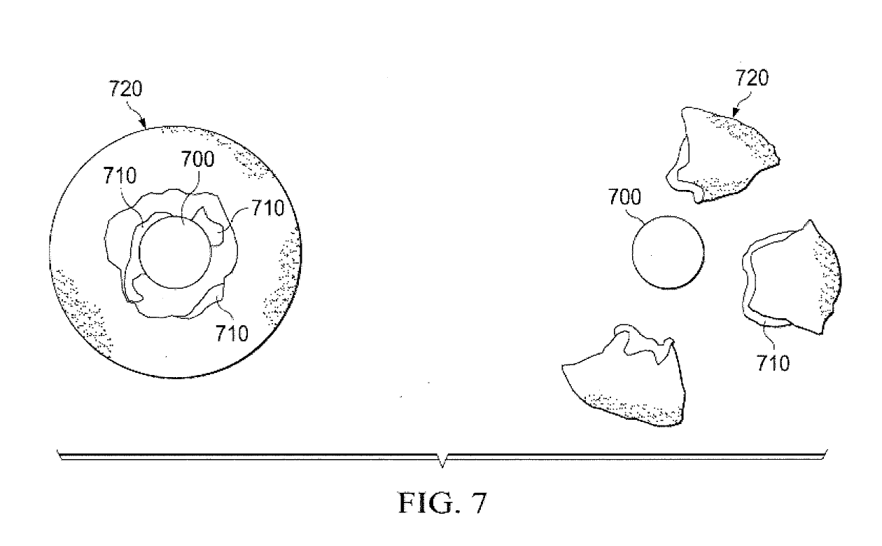

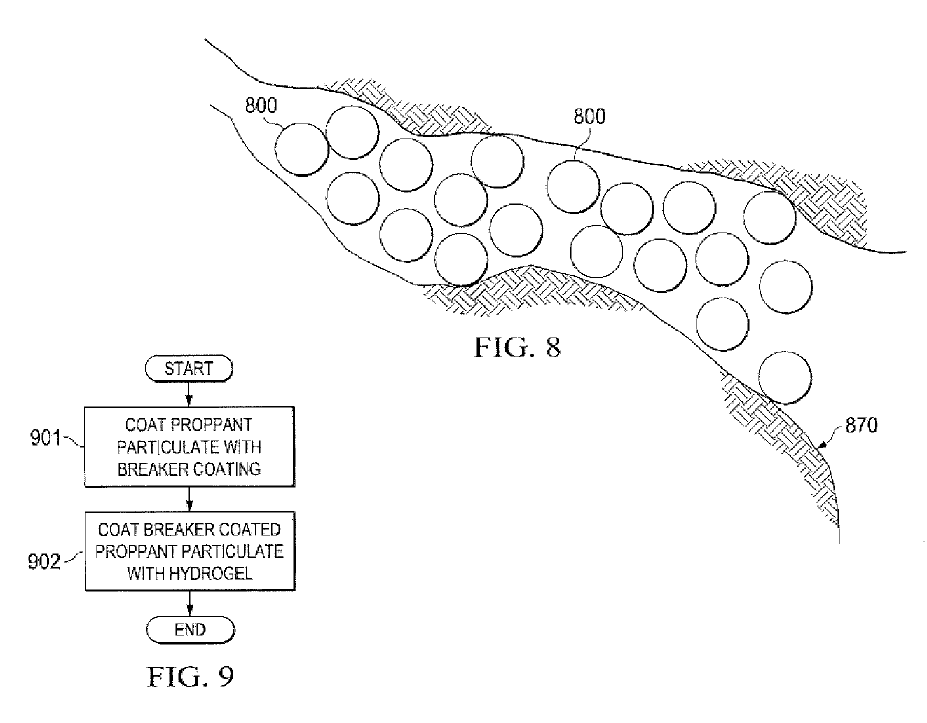

FIG. 7 illustrates a schematic view of a breaker coating 710 on a proppant particulate 700 breaking and causing the hydrogel coating 720 to separate from the proppant particulate 700 according to an illustrative embodiment. Finally, as shown in FIG. 8, a plurality of proppant particulates 800 remains in a fracture 870 thereby allowing oil or gas to flow according to an illustrative embodiment. Particularly, as shown in FIG. 8, the plurality of proppant particulates 800 that is left holding the fracture 870 open is free of any hydrogel coating.

FIG. 9 illustrates a flowchart of a method of treating a proppant particulate. The method of treating a proppant particulate according to an illustrative embodiment includes coating the proppant particulate with a breaker coating 901, and coating the breaker coated proppant particulate with a hydrogel 902. In some embodiments, coating the proppant particulate with the breaker coating 901 includes providing a tackifying agent in the breaker coating to adhere the breaker coating to the proppant particulate. The tackifying agent may also be provided to adhere the hydrogel to the breaker coated proppant particulate. When a tackifying agent is provided in the breaker, the tackifying agent in a dry state may exhibit characteristics that adhere the breaker and hydrogel and in a wet state exhibit characteristics that repel the hydrogel from the breaker.

According to some embodiments, the method further includes coating the breaker coated proppant particulate with an encapsulating agent, wherein the encapsulating agent is at least one from a group consisting of Polyvinylidene Chloride (PVDC), Polyvinylidene Acetate (PVDA), polylactic acid, polyvinyl alcohol, and combinations or derivative thereof. The proppant particulate having a breaker coating and an encapsulating agent may then be coated with the hydrogel.

In some embodiments, the method also includes breaking up crosslinking and/or the molecular structure of polymer chains in the hydrogel using the breaker coating in a wet state. The breaking up the crosslinking and molecular structure of polymer chains in the hydrogel using the breaker coating includes breaking up the crosslinking and the molecular structure of polymer chains in the hydrogel in a wet state at a rate based on at least one or more of temperature, pressure, concentration, time elapsed, or any combination thereof.

As provided in the current disclosure, because a breaker coating is coated directly onto a surface of each individual proppant particulate, the hydrogel coating that is placed on the breaker coated proppant particulates is removed with ease from the proppant particulate surface leaving no residual hydrogel polymer on the proppant particulate after breaking and removal of the fracturing fluid is complete. This in turn is beneficial because residue free proppant particulate has substantially increased proppant pack conductivity and hydrocarbon production.

There are some additional advantages provided by a proppant particulate that is coated with an initial breaker coating followed by a hydrogel coating and a method for treating the proppant particulate. For example, providing the breaker coating and the hydrogel, which is a cross-linkable polymer, on the proppant particulate allows for a lower usage of gelling polymer and breaker in the fracturing fluid. Thus, an economic benefit may be provided by a reduction in breaker and gelling polymer loading of the fracturing fluid. Additionally, providing the breaker coating underneath the hydrogel polymer coating on the proppant particulate provides for the removal of the hydrogel polymer and residues completely from the proppant particulate surface increasing the proppant pack conductivity. This improved conductivity is provided when the coated-breaker removes gel residue from the proppant surface completely. Additionally, being able to pre-coat a plurality of proppant particulates in a dry state provides a practical and economical approach for flexibility when and where the proppant particulate can be treated to make a self-supporting proppant particulate. Also, improved proppant transport is provided by the stability of the self-supporting proppant particulate in a dry state. Further, the ability of the self-supporting proppant particulates to space apart in a wet state provides control of a proppant concentration that helps ensure the well is not overwhelmed with proppant causing a screen-out, which is also sometimes called a screen-off.

More benefits of the breaker and hydrogel coated proppant particulate include a lower tendency to erode equipment, a lower friction coefficient in the wet state, good bonding adhesion between each proppant particulate after placement in a fracture, resistance to uncontrolled fines migration, as well as the increased proppant pack conductivity. These benefits and advantages may additionally increase customer acceptance of self-supporting proppant particulate technology.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

We claim:

1. A proppant that is self-supporting, the proppant comprising:
a proppant particulate;
a breaker coating adhered to a surface of the proppant particulate; and
a hydrogel coating adhered to the breaker coating.

2. The proppant of claim 1, wherein the breaker coating further comprises:
a tackifying agent to adhere the breaker coating to the proppant particulate and the hydrogel coating to the breaker coating,
wherein the tackifying agent adheres the breaker coating to hydrogel coating when the hydrogel coating is in a dry state, and
wherein the tackifying agent repels the hydrogel coating when the hydrogel coating is in a wet state.

3. The proppant of claim 1, wherein the tackifying agent is selected from the group consisting of rosins, terpenes, aliphatic resins, cycloaliphatic resins, aromatic resins, hydrogenated hydrocarbon resins, terpene-phenol resins, and combinations or derivative thereof.

4. The proppant of claim 1, wherein the breaker coating adheres to the proppant particulate and hydrogel in a dry state.

5. The proppant of claim 1, wherein the breaker coating breaks up crosslinking and a molecular structure of polymer chains in the hydrogel in a wet state over time.

6. The proppant of claim 5, wherein the breaker coating breaks up the crosslinking and the molecular structure of polymer chains in the hydrogel in a wet state at a rate dependent on at least one of a temperature, a pressure, a concentration, time elapsed, and combinations or derivative thereof.

7. The proppant of claim 1, wherein the breaker coating is selected from the group consisting of an oxidative breaker, an acid breaker including a chelating agent breaker, a delayed release acid breaker, a delayed release enzyme breaker, a temperature activated breaker, a hydrolysable ester breaker, and combinations or derivative thereof.

8. The proppant of claim 1, further comprising:
a consolidating agent coating adhered to the surface of the proppant particulate,
wherein the consolidating agent is selected from the group consisting of a non-aqueous tackifying agent, an aqueous tackifying agent, a silyl-modified polyamide compound, a curable resin, a crosslinkable aqueous polymer composition, a polymerizable organic monomer composition, a zeta potential-modifying aggregating composition, a silicon-based resin, a binder, a consolidation agent emulsion, and combinations or derivative thereof.

9. The proppant of claim 1, wherein the particulate is selected from the group consisting of sand, treated sand, crushed nut hulls, glass beads, polymer beads, man-made ceramic materials, and combinations or derivative thereof.

10. The proppant of claim 1, further comprising:
an encapsulating agent that coats the breaker coated proppant particulate,
wherein the encapsulating agent is selected from the group consisting of Polyvinylidene Chloride (PVDC), Polyvinylidene Acetate (PVDA), polylactic acid, polyvinyl alcohol, and combinations or derivative thereof.

11. A method of treating a proppant particulate, the method comprising:
coating the proppant particulate with a breaker coating; and
coating the breaker coated proppant particulate with a hydrogel.

12. The method of claim 11, wherein the coating the proppant particulate with the breaker coating comprises:
using a tackifying agent in the breaker coating to adhere the breaker coating to the proppant particulate.

13. The method of claim 12, wherein the coating the breaker coated proppant particulate with the hydrogel further comprises:
using the tackifying agent in the breaker coating to adhere the hydrogel to the breaker coated proppant particulate.

14. The method of claim 13, wherein the using the tackifying agent in the breaker coating to adhere the hydrogel to the breaker coated proppant particulate further comprises:
adhering the hydrogel to the breaker coated proppant particulate using the tackifying agent in a dry state; and
repelling the hydrogel from the breaker coated proppant particulate when the hydrogel is in a wet state.

15. The method of claim 11, further comprising:
breaking up crosslinking and a molecular structure of polymer chains in the hydrogel using the breaker coating in a wet state at a rate dependent on at least one of a temperature, a pressure, a concentration, or time elapsed.

16. The method of claim 11, further comprising:
coating the breaker coated proppant particulate with an encapsulating agent.

17. The method of claim 16, wherein the encapsulating agent is selected from the group consisting of Polyvinylidene Chloride (PVDC), Polyvinylidene Acetate (PVDA), polylactic acid, polyvinyl alcohol, and combinations or derivative thereof.

18. A method of using a proppant particulate in a subterranean formation, the method comprising:
introducing a fracturing fluid and a proppant particulate into a subterranean formation through a well bore, wherein a breaker coating is adhered to a surface of the proppant particulate and a hydrogel coating is adhered to the breaker coating;
placing the proppant particulate in a fracture of the subterranean formation; and
removing the breaker coating from the proppant particulate.

19. The method of claim 18 further comprises mixing the fracturing fluid and proppant particulate using mixing equipment.

20. The method of claim 18 wherein the fracturing fluid and proppant particulate are introduced into the subterranean formation using one or more pumps.
